(19) United States
(12) Patent Application Publication
(10) Pub. No.: US 2017/0205040 A1
(43) Pub. Date: Jul. 20, 2017

(54) DEVICE AND METHOD FOR PROJECTING A LIGHT PATTERN

(71) Applicant: Robert Bosch GmbH, Stuttgart (DE)

(72) Inventor: Mihel Seitz, Eningen Unter Achalm (DE)

(21) Appl. No.: 15/403,338

(22) Filed: Jan. 11, 2017

(30) Foreign Application Priority Data
Jan. 19, 2016 (DE) 102016200586.3

(51) Int. Cl. F21S 8/10; G02B 27/14; F21V 8/00

(52) U.S. Cl. CPC F21S 48/1388; G02B 6/0006; G02B 6/0008; F21S 48/114; F21S 48/1241; F21S 48/1757; G02B 27/141

(57) ABSTRACT

A device and a method for projecting a light pattern. The device includes a mirror array having a number of individual mirrors; a provision device designed to provide a light beam conducted onto the mirror array; a conducting device; and a light return guide device. The individual mirrors are designed to, in a first position, reflect first portions of the light impinging on the mirror array toward the conducting device, and, in a second position, to reflect second portions toward the light return guide device, according to the light pattern to be projected. The conducting device conducts the first portions for the projection of the light pattern; and the light return guide device guides the second portions back onto the mirror array.

### CROSS REFERENCE

The present application claims the benefit under 35 U.S.C. §119 of German Patent Application No. DE 102016200586.3 filed on Jan. 19, 2016, which is expressly incorporated herein by reference in its entirety.

### FIELD

The present invention relates to device and to a method for projecting a light pattern, having a light return guide.

### BACKGROUND INFORMATION

Devices for projecting images can be used for example as projectors, e.g., as beamers, or for adaptive headlight systems. In both cases, light is to be sent out in particular directions or at particular spatial angles, in a purposive fashion that can be adapted as needed, and is not to be sent out in other directions or at other angles. Standardly, a limited quantity of light, i.e. a clearly defined light flux, is present that is to be optimally made use of. If, for example, during travel on a curve with a vehicle having adaptive cornering lights, a curve is to be particularly well-illuminated, then the available light flux is to be directed onto the curve in a particularly efficient manner.

A technology frequently used for the targeted deflection of light, i.e., for projecting a light pattern, is for example DLP (Digital Light Processing). In the DLP method, light is directed onto an array of micro-mirrors that can be individually controlled so as to, in a first position, direct the light towards the desired imaging location, whereby a bright pixel results at the image location, and, in a second position, to direct light for example onto a light absorber, whereby a dark pixel arises at the image location. Through the totality of the light beams reflected at the image location, the light pattern that is to be projected results from the bright and dark pixels. A lamp unit and a display device of a projection system are described, for example. in U.S. Patent Appl. Pub. No. 2005/0185408 A1.

DLP projectors can be used for example in vehicle headlights, so that these headlights send out light according to so-called shift patterns, i.e., send out light for projecting light patterns that are adapted to the respective driving situation. For example, it can be provided that curves are illuminated corresponding to their curve radius.

### SUMMARY

In accordance with an example embodiment of the present invention, a device is provided for projecting a light pattern having a provision device, a conducting device, a light return guide device, and a mirror array having a number of individual mirrors. The provision device is designed to provide a light beam that is conducted onto the mirror array. The individual mirrors of the mirror array are each designed to, in a respective first position, reflect first portions of light impinging on the mirror array toward the conducting device, in accordance with the image to be projected. Moreover, the individual mirrors are each designed to, in a respective second position, reflect second portions of the light impinging on the mirror array toward the light return guide device. The conducting device is designed to conduct the first portions reflected toward the conducting device for the projection of the light pattern to be projected, in particular to couple them out from the device. The light return guide device is designed to guide the second portions reflected onto the light return guide device back to the mirror array, in particular to conduct them parallel to the light beam provided by the provision device. Thus, the light impinging on the mirror array is to be understood in particular as the sum of the provided light beam and of the returned second portions.

In addition, a method is provided having the steps: provision of a light beam; conducting of the provided light beam onto a mirror array having a number of individual mirrors; reflection by the individual mirrors of first portions of the light impinging on the mirror array towards a conducting device in accordance with the image to be projected; reflection of second portions of the light impinging on the mirror array, in a respective second position of the individual mirrors, towards a light return guide device in accordance with the image to be projected; conducting by the conducting device of the first portions reflected toward the conducting device for the projection of the light pattern that is to be projected; and returning of the second portions reflected toward the light return guide device back onto the mirror array, in particular parallel to the provided light beam.

In accordance with the present invention, in a device that functions according to the DLP design for projecting a light pattern, light that is not needed back to the original light flux is supplied. In this way, the original light flux, in particular provided by a light source, is exploited particularly efficiently, because even portions of the light flux not currently needed for the projection are again deflected onto the mirror array, so that they are again available for projecting the light pattern.

By selectively returning the light portions not required for the projection into the originally provided light flux, a power level that is to be reserved for producing the light flux can be reduced. In this way, the energy efficiency, e.g., of a DLP-based headlight system can be increased. Particularly advantageously, the device according to the present invention can be used in a shifting light, a roadway marking light, or some other marking light, or can be fashioned as such a light. The present invention thus also provides a vehicle having at least one device according to the vehicle as vehicle headlight.

Advantageous specific embodiments and developments are described herein with reference to the Figures.

According to a preferred development, the light return guide device includes a first reflector device that is situated between the provision device and the mirror array, and that is designed to predominantly let through, i.e., to transmit, the light beam from the provision device to the mirror array.

When there are references herein to a reflection or a transmission, it is always to be understood that a complete reflection or transmission cannot be achieved. Unless otherwise explicitly indicated, a reflection or transmission is to be understood as any notable reflection or transmission, but in particular a reflection or transmission of at least 50%, preferably at least 75%, preferably at least 90%, particularly preferably at least 95%, still more preferably at least 98%, quite particularly preferably more than 99%.

The first reflector device can advantageously be used to allow light beams that are oriented parallel to the provided light beam to pass through, and to reflect or to block other light beams, for example anti-parallel light beams. Moreover, the device can have a second reflector device that is situated and fashioned such that the second portions of the light impinging on the mirror array are reflected onto the second reflector device by the individual mirrors. Both the first and the second reflector device can be situated so as to be rotationally fixed relative to the mirror array. Thus, in particular through the interaction of the first and the second reflector device, the percentage of the provided light beam not currently being used for the projection of the light pattern that is to be projected, i.e., the second portions, can be guided back onto the mirror array for further use. A reflector device, or also a mirror, is to be understood as any device or system that is suitable for reflecting a light beam, for example reflective metal or glass surfaces, DBR reflectors (distributed Bragg reflectors), mirror arrays, etc. Elements designated as mirrors and as reflector devices can be fashioned identically or differently from each other.

According to a further preferred development, the second reflector device is fashioned and situated in such a way that the second portions reflected toward the light return guide device impinge frontally on the second reflector device, which is in particular configured so as to be rotationally fixed relative to the mirror array. In other words, it can be provided that the second portions impinge in perpendicular fashion on a reflective plane of the second reflector surface. In this way, it can be achieved that the second portions are reflected at an angle of 180°, i.e., experience a return reflection. This means that the second portions are reflected back onto the mirror array. The second portions reflected in this way by the second reflector device thus impinge on the respective individual mirrors at the same angle by which they were reflected, and are thus reflected away from the mirror array anti-parallel to the provided light beam.

According to a further preferred development, the first reflector device is fashioned such that it reflects light beams impinging on the first reflector device from the direction of the mirror array, i.e., the second portions, by 180°, and thus reflects these toward the mirror array parallel to the provided light beam. In this way, a particularly simple light return guide device can be provided that requires the adjustment of only two reflector devices, e.g., mirrors, in the beam path, and is therefore particularly easy to set up, calibrate, and maintain.

According to a further preferred development, the first reflector device is fashioned as a beam combiner that transmits the light beam that is provided by the provision device from a first direction and that impinges on the beam combiner, for example as described in more detail above. The second reflector device can be designed and configured to reflect the second portions reflected at the light return guide device onto the first reflector device, fashioned as beam combiner. The first reflector device, fashioned as beam combiner, can be configured such that the light beams reflected by the second reflector device onto the first reflector device impinge on a second surface of the beam combiner at an angle of 90° to the first direction, and in this way are reflected toward the mirror array parallel to the provided, transmitted light beam. In this way, light losses can be further reduced, for example those due to repeated reflection at the mirror array. The beam combiner can be designed to combine the second portions reflected onto the beam combiner with the provided light beam.

According to a further preferred development, at least one polarization shifter, for example a half-wave plate, is situated between the mirror array and the second reflector device and/or between the second reflector device and the first reflector device. The polarization shifter can also be fashioned as a polarization filter. The polarization shifter is fashioned to shift a polarization of the light beams impinging on it or passing through it, i.e. the second portions. Thus, light losses, e.g., at the first reflector device fashioned as beam combiner can be reduced, because standard beam combiners are more efficient for polarized light.

According to a further preferred development, the light return guide device has a coupling-in device and a coupling-out device that are connected by a fiber optic cable, the coupling-in device being designed and configured to couple the second portions, reflected toward the light return guide device, into the fiber optic cable, and the coupling-out device being designed and configured to couple the second portions out from the fiber optic cable and to couple them into the light beam provided by the provision device.

According to a further preferred development, the provision device provides the light beam in a fiber optic cable, which is combined with the fiber optic cable of the light return guide device by the coupling-out device. Thus, the second portions can be again particularly efficiently combined with the originally provided light beam, which overall can further increase the light yield. In other words, light losses can be minimized, further reduced, or mitigated.

According to a further preferred development, the device according to the present invention is fashioned as a headlight, in particular a vehicle headlight, i.e., a headlight in a vehicle or for installation in a vehicle.

### BRIEF DESCRIPTION OF THE DRAWINGS

The present invention is explained in more detail below on the basis of the exemplary embodiments shown in the Figures.

FIG. 1 shows a schematic diagram of a device for projecting a light pattern according to a specific embodiment of the present invention.

FIG. 2 shows a schematic representation of a device for projecting a light pattern according to a further specific embodiment of the present invention.

FIG. 3 shows a schematic representation of a device for projecting a light pattern according to another specific embodiment of the present invention.

FIG. 4 shows a schematic representation of a device for projecting a light pattern according to another specific embodiment of the present invention.

FIG. 5 shows a schematic flow diagram for the explanation of a method for projecting a light pattern according to a further specific embodiment of the present invention.

### DETAILED DESCRIPTION OF EXAMPLE EMBODIMENTS

In the Figures, identical or functionally identical elements and devices have been provided with the same reference characters, unless otherwise indicated. The numbering of method steps is intended to provide clarity, and in particular is not intended to imply a particular temporal sequence, unless otherwise indicated. In particular, a plurality of method steps can also be carried out simultaneously.

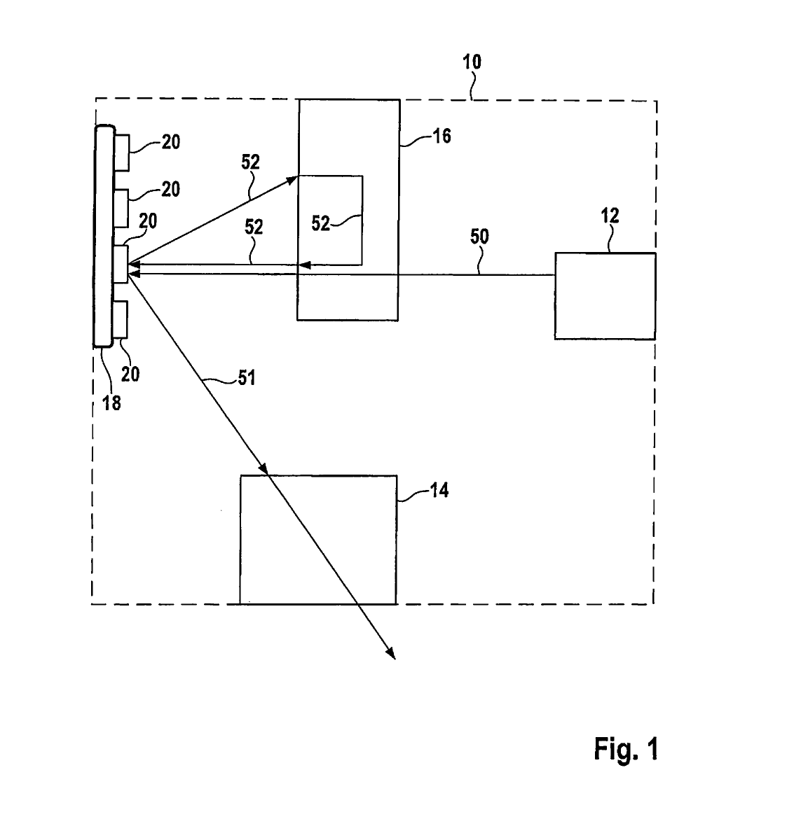

FIG. 1 shows a schematic diagram of a device 10 for projecting a light pattern according to a specific embodiment of the present invention.

The device 10 has a mirror array 18 having a number of individual mirrors 20. Device 10 moreover has a provision device 12 that is designed to provide a light beam 50 that is conducted onto mirror array 18. The conducting of light beam 50 can take place for example by provision device 12, in an open and/or evacuated space, and/or using additional optical elements. The provision device can include fiber optic cables, optical elements such as lenses and diaphragms, or the like, or can be made up of these.

Device 10 in addition has a conducting device 14 and a light return guide device 16. The individual mirrors 20 of mirror array 18 are each designed to reflect, in a respective first position, first portions of light 50, 52 impinging on mirror array 18 in the direction of conducting device 14, according to the light pattern that is to be projected. Individual mirrors 20 are in addition designed to, in a respective second position, reflect second portions 52 of the light 50, 52 impinging on mirror array 18 to conducting device 14. Mirror array 18 can in particular also be fashioned as a micro-mirror array, the individual mirrors 20 being fashioned as micro-mirrors.

Device 10 can in addition have a control device that is designed to control micro-mirrors 20 of mirror array 18 in accordance with the light pattern that is to be projected, so that they assume the first and the second position depending on the light pattern that is currently to be projected. In other words, individual mirrors 20 are designed to switch at least between the first position and the second position. The mirror array can also have an interface in order to receive control signals from an external control device, according to which signals the individual mirrors 20 are controlled in order to project the light pattern that is to be projected.

Conducting device 14 is designed to conduct first portions 51 for projecting the light pattern to be projected, for example to couple them out from device 10. The conducting device can for this purpose include for example fiber optic cables, lenses, diaphragms, and/or other optical elements, and/or can be made up of them. Light return guide device 16 is designed to guide second portions 52 of the light 50, 52 impinging on mirror array 18 back onto mirror array 18, in particular parallel to provided light beam 50.

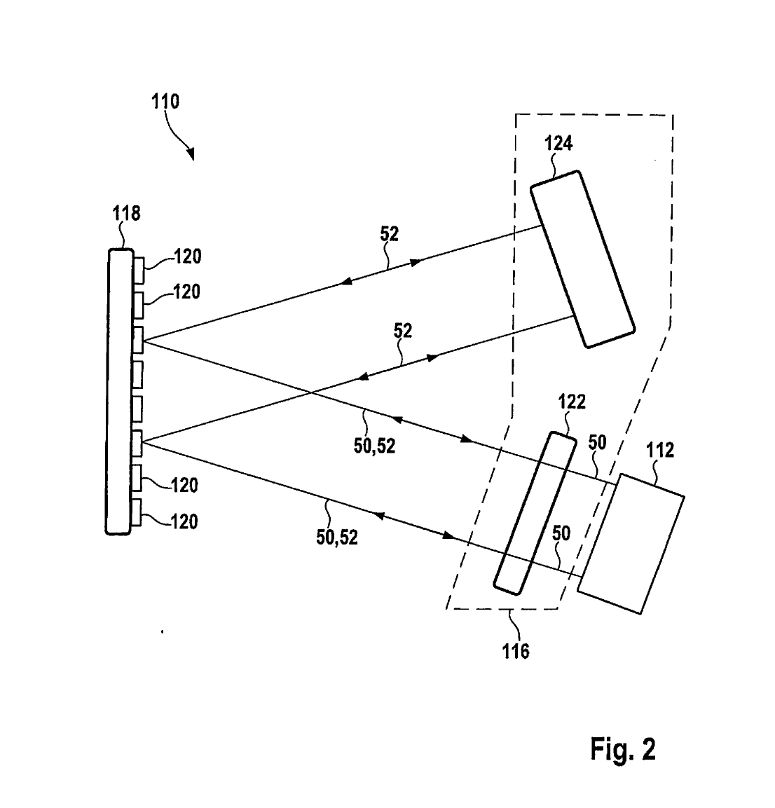

FIG. 2 shows a schematic representation of a device 110 for projecting a light pattern according to a further specific embodiment of the present invention.

Device 110 is a variant of device 10, and can be modified according to all developments described with reference to device 10. Device 110 includes a conducting device 14 (not shown) as described above. As provision device for providing a light beam 50, device 110 has a light source 112, e.g., for white or monochromatic, in particular blue, light. Light source 112 and a micro-mirror array 118 having a number of micro-mirrors 20 is fashioned as a first reflector device 122, transparent at one side, for example as a one-way transparent mirror. For example, a dichroic mirror can be used. First reflector device 122 transmits provided light beam 50 from light source 112 to micro-mirror array 118, but reflects light beam portions that impinge in anti-parallel fashion.

Device 110 moreover has a second reflector device 124 that is fashioned, as described in relation to device 10, to reflect second portions 52 of light beam 50, which are reflected by micro-mirrors 20 in the respective second position toward second reflector device 124, back to the respective micro-mirrors 120. Because the speed of light is significantly greater than the standard speeds of rotation of micro-mirrors 120, micro-mirrors 120 are still in the second position when the second portions are reflected back onto micro-mirrors 120 by second reflector device 124, so that the second portions are again reflected back in the direction of light source 112 and first reflector device 122. At first reflector device 122, the second portions are again reflected in the direction toward micro-mirror array 118, and are thus configured parallel to originally provided light beam 50, so that they are again available for the DLP projection. The first and second reflector device 122, 124 thus together form a light return guide device 116 of device 110, by which second portions 52 of the light 50, 52 impinging on micro-mirror array 118 can be guided back onto micro-mirror array 18.

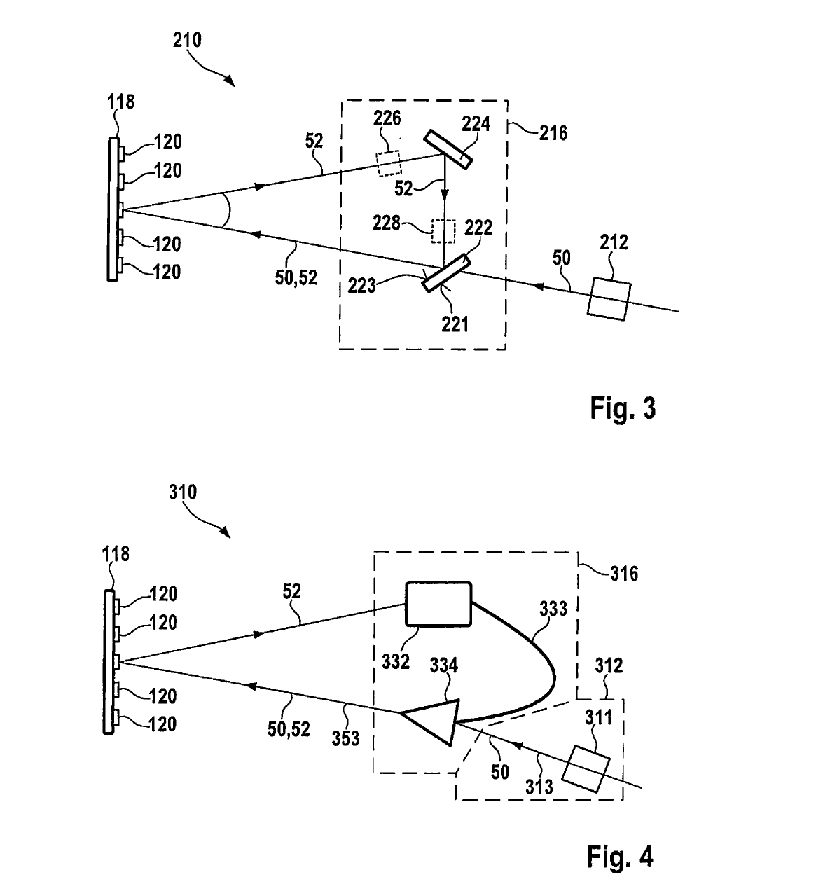

FIG. 3 shows a schematic representation of a device 210 for projecting a light pattern according to another specific embodiment of the present invention.

Device 210 can be regarded as a variant of device 10, in particular as a variant of device 110. Device 110 includes a conducting device 14 (not shown) as described above. Device 10 has, as a provision device for providing light beam 50, an initial coupling-in device 212 that is designed to couple externally produced light, directed onto initial coupling-in device 212, into device 210. Initial coupling-in device 212 can also be used in device 110 instead of light source 112; likewise, a light source as described with reference to light source 112, can be used in device 210 instead of initial coupling-in device 212.

A first reflector device 222 of device 210 is fashioned as a beam combiner 222. Beam combiner 222 is situated relative to initial coupling-in device 212 in such a way that the light beam 50 provided by initial coupling-in device 212 impinges at an angle of 45° on a first surface 221 of first reflector device 222, and is thus transmitted predominantly, preferably more than 75%, preferably more than 90%, in particular more than 98%, in a straight line onto micro-mirror array 118 having micro-mirrors 120. Micro-mirror array 118 is fashioned as described in relation to device 110. Device 210 further includes a second reflector device 224, for example a mirror or a DBR reflector. Second reflector device 224 is fashioned and situated such that the second portions 52 of the light 50, 52 impinging on micro-mirror array 118, reflected by micro-mirrors 120 in the respective second position, are reflected toward second reflector device 224, and are reflected by this device onto a second surface 223 of first reflector device 222, fashioned as a beam combiner.

The second portions 52 preferably impinge on second surface 223 of first reflector device 222 at an angle of 45°, and are reflected there in such a way that the thus reflected second portions 52 are situated parallel to the transmitted provided light beam 50, and are thus returned to micro-mirror array 118. Second surface 223 of first reflector device 222 is preferably a surface facing away from first surface 221 of first reflector device 222.

As is shown as an example in FIG. 3, a first polarization shifter 226 can be situated for example in the beam path between micro-mirror array 118 and second reflector device 224, and/or a second polarization shifter can be situated in the beam path between second reflector device 224 and first reflector device 222, the first and/or the second polarization shifter 226, 228 being designed to shift or modify a respective polarization of second portions 52 passing through them. Thus, it can be provided that the second portions 52 impinge on second surface 223 of first reflector device 222 in polarized, or re-polarized, fashion, whereby a reflection portion on first reflector device 222 can increase. First reflector device 222 and second reflector device 224, optionally together with first and/or second polarization shifter 226, 228, together form light return guide device 216 of device 210.

The respective provision device, for example light source 112 and/or initial coupling-in device 212, can each be designed to provide, i.e., to produce or to couple in, blue light, in particular having a wavelength between 430 nm and 490 nm.

Alternatively, however, white light can also be provided, i.e., produced or coupled in, or light having any other wavelength, for example in the infrared range or in the UV range, can also be provided. White light is to be understood as light mixed from portions of a plurality of, in particular all, wavelengths of the visible spectral range, in particular with equal energy levels.

FIG. 4 shows a schematic representation of a device 310 for projecting a light pattern according to another specific embodiment of the present invention. Device 310 is a variant of device 10, and can be adapted according to all modifications and developments described with regard to device 10. Device 310 includes a conducting device 14 (not shown) as described above.

Device 310 has a provision device 312 that has, besides a light source 311 (for example fashioned as light source 112 of device 110) and/or an initial coupling-in device (such as for example initial coupling-in device 212 of device 210), a first fiber optic cable 313. Light beam 50 provided by light source 311 and/or by the initial coupling-in device is conducted by first fiber optic cable 313. The second portions 52, reflected by micro-mirrors 120 in the respective second position, of light 50, 52 impinging on micro-mirror array 118, in particular on micro-mirrors 120, are reflected toward a coupling-in device 332.

Coupling-in device 332 is set up and configured so as to partly, preferably completely, receive second portions 52 reflected onto it, and to couple them into a second fiber optic cable 333. The second portions 52 are conducted to a coupling-out device 334 by second fiber optic cable 333. Coupling-out device 334 is designed to integrate first fiber optic cable 313 and second fiber optic cable 333 with one another in such a way that second portions 52 are conducted back to micro-mirror array 118 parallel to provided light beam 50 or integrated into provided light beam 50, for example at least partly with the aid of a third fiber optic cable 353 between coupling-out device 334 and micro-mirror array 118. The light conduction of provided light beam 50 can also take place without first fiber optic cable 313; in this case, coupling-out device 334 is designed to couple second portions 52 out from second fiber optic cable 333 in such a way that second portions 52 are returned to micro-mirror array 118 parallel to light beam 50 or integrated into light beam 50. Coupling-in device 332, second fiber optic cable 333, and coupling-out device 334 together form a light return guide device 316 of device 310.

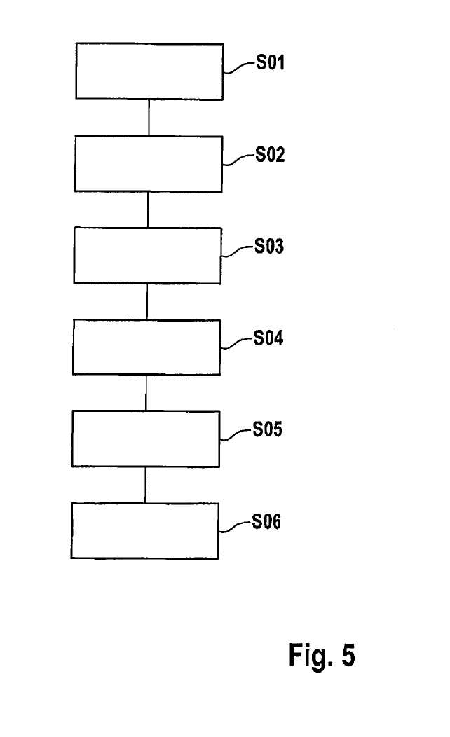

FIG. 5 shows a schematic flow diagram for the explanation of a method for projecting a light pattern according to a further specific embodiment of the present invention.

The method according to FIG. 5 can be carried out with the device according to the present invention, in particular with one of the devices 10; 110; 210; 310 according to the present invention, and can be adapted according to all modifications and developments described with regard to the device according to the present invention, and vice versa.

In a step S01, a light beam 50 is provided, for example by a provision device 12; 112; 212; 312. In a step S02, provided light beam 50 is conducted onto a mirror array 18, 118 having a number of individual mirrors 20; 120. In a step S03, first portions 51 of light 50, 52 impinging on mirror array 18; 118 are reflected by individual mirrors 20; 120 toward a conducting device 14, according to the image to be projected. In a step S04, second portions 52 of light 50, 52 impinging on mirror array 18; 118 are reflected, in a respective second position of individual mirrors 20; 120, toward a light return guide device 16; 116, 216, 316, according to the image to be projected. In a step S05, first portions 51 reflected toward conducting device 14 are conducted, for example coupled out, by conducting device 14, for the projection of the light pattern to be projected. In a step S06, second portions 52 reflected toward light return guide device 16; 116; 216; 316 are guided back onto mirror array 118.

What is claimed is:

1. A device for projecting a light pattern, comprising:
a mirror array having a number of individual mirrors;
a provision device designed to provide a light beam conducted onto the mirror array;
a conducting device; and
a light return guide device;
wherein the individual mirrors are respectively designed to, in a respective first position, reflect first portions of light impinging on the mirror array toward the conducting device, and, in a respective second position, to reflect second portions of the light impinging on the mirror array toward the light return guide device, according to the light pattern to be projected;
wherein the conducting device is designed to conduct the first portions for the projection of the light pattern; and
wherein the light return guide device is designed to guide the second portions back onto the mirror array.

2. The device as recited in claim 1, wherein the light return guide device includes a first reflector device that is situated between the provision device and the mirror array and that is designed to predominantly transmit the light beam from the provision device to the mirror array; and the light return guide device has a second reflector device that is situated and designed such that the second portions of the light impinging on the mirror array are reflected by the individual mirrors toward the second reflector device.

3. The device as recited in claim 2, wherein the second reflector device is fashioned and situated such that the second portions reflected toward the light return guide device impinge frontally on the second reflector device.

4. The device as recited in claim 2, wherein the first reflector device being fashioned as a beam combiner that transmits the light beam provided by the provision device and impinging on the beam combiner; and the second reflector device is designed and configured to reflect the second portions, reflected to the light return guide device, toward the beam combiner; and the beam combiner is designed to combine the second portions, reflected onto the beam combiner, with the provided light beam.

5. The device as recited in claim 2, wherein at least one polarization shifter is situated at least one of: i) between the mirror array and the first reflector device, and ii) between the second reflector device and the first reflector device, and wherein the polarization shifter is fashioned to shift a polarization of the second portions impinging on it or passing through it.

6. The device as recited in claim 1, wherein the light return guide device has a coupling-in device and a coupling-out device that are connected by a first fiber optic cable, the coupling-in device being designed and configured to couple the second portions reflected toward the light return guide device into the first fiber optic cable; and wherein the coupling-out device is designed and configured to couple the second portions out from the first fiber optic cable and to couple them back into the provided light beam.

7. The device as recited in claim 6, wherein the provision device provides the light beam in a second fiber optic cable that is combined with the first fiber optic cable of the light return guide device by the coupling-out device.

8. The device as recited in claim 1, wherein the device is a vehicle headlight.

9. A vehicle having a headlight, the headlight projecting a light pattern, the headlight comprising:
a mirror array having a number of individual mirrors;
a provision device designed to provide a light beam conducted onto the mirror array;
a conducting device; and
a light return guide device;
wherein the individual mirrors are respectively designed to, in a respective first position, reflect first portions of light impinging on the mirror array toward the conducting device, and, in a respective second position, to reflect second portions of the light impinging on the mirror array toward the light return guide device, according to the light pattern to be projected;
wherein the conducting device is designed to conduct the first portions for the projection of the light pattern; and
wherein the light return guide device is designed to guide the second portions back onto the mirror array.

10. A method for projecting a light pattern, comprising:
providing a light beam;
conducting the provided light beam onto a mirror array having a number of individual mirrors;
reflecting, by the individual mirrors, first portions of the light impinging on the mirror array toward a conducting device, according to an image that is to be projected;
reflecting second portions of the light impinging on the mirror array, in a respective second position of the individual mirrors, toward a light return guide device, according to the image to be projected;
conducting, by the conducting device, the first portions reflected toward the conducting device, for the projection of the light pattern; and
returning the second portions, reflected toward the light return guide device, back onto the mirror array.
